(19) United States
(12) Patent Application Publication
(10) Pub. No.: US 2017/0203737 A1
(43) Pub. Date: Jul. 20, 2017

(54) ADAPTOR FOR A LIFT JACK

(71) Applicants: Alex Cho, Chantilly, VA (US); Young Han Cho, Ashburn, VA (US)

(72) Inventors: Alex Cho, Chantilly, VA (US); Young Han Cho, Ashburn, VA (US)

(21) Appl. No.: 15/411,246

(22) Filed: Jan. 20, 2017

Related U.S. Application Data
(60) Provisional application No. 62/281,003, filed on Jan. 20, 2016.

(51) Int. Cl. B60S 9/22; B60S 9/04; B66F 1/02

(52) U.S. Cl. CPC B60S 9/22; B66F 1/02; B60S 9/04; B66F 2700/123

(57) ABSTRACT

In an example, an adaptor for a lift jack may include a pair of coextensive segments having a pair of openings at a first end, and defining a space to receive a portion of a lift jack at a second end. The adaptor may also include a coupling pin that is to be inserted through the pair of openings to secure the adaptor to a vehicle. The second end of the coextensive segments may have a notch on each segment to receive the portion of the lift jack.

### BACKGROUND

Lift jacks are typically used to lift vehicles when it becomes necessary to change tires or to make minor repairs to the wheels of the vehicles. Lift jacks are available in many different sizes and configurations to enable vehicles to be lifted at different locations on the vehicles. For instance, certain types of lift jacks are suited for lifting vehicles along the frames of the vehicles, while others are suited for lifting vehicles along their bumpers.

### BRIEF DESCRIPTION OF THE DRAWINGS

Features of the present disclosure are illustrated by way of example and not limited in the following figure(s), in which like numerals indicate like elements, in which:

FIG. 1A shows a view of an adaptor, a lift jack, and a vehicle, according to an example of the present disclosure;

FIG. 1B shows view of an adaptor, a lift jack, and a vehicle, according to an example of the present disclosure;

FIGS. 2A-2D, respectively, show various views of the adaptor, according to an example of the present disclosure;

FIG. 3A shows a view of the adaptor system, according to an example of the present disclosure;

FIG. 3B shows an exploded view of the adaptor system depicted in FIG. 3A, according to an example of the present disclosure;

FIG. 4 shows a flow diagram of a method for implementing a lift jack adaptor, according to an example of the present disclosure.

### DETAILED DESCRIPTION

For simplicity and illustrative purposes, the present disclosure is described by referring mainly to an example thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. As used herein, the terms “a” and “an” are intended to denote at least one of a particular element, the term “includes” means includes but not limited to, the term “including” means including but not limited to, and the term “based on” means based at least in part on.

Disclosed herein is an adaptor for a lift jack. The adaptor is to be coupled to a tab of a bumper of a vehicle to enable the vehicle to be lifted via the bumper with a lift jack. Particularly, the adaptor is to be coupled to the tab of the bumper through insertion of a coupling pin through the adaptor and through the tab of the bumper. In one regard, therefore, the adaptor disclosed herein enables vehicles to be lifted up from the ground through use of a lift jack in a relatively safe and easy manner.

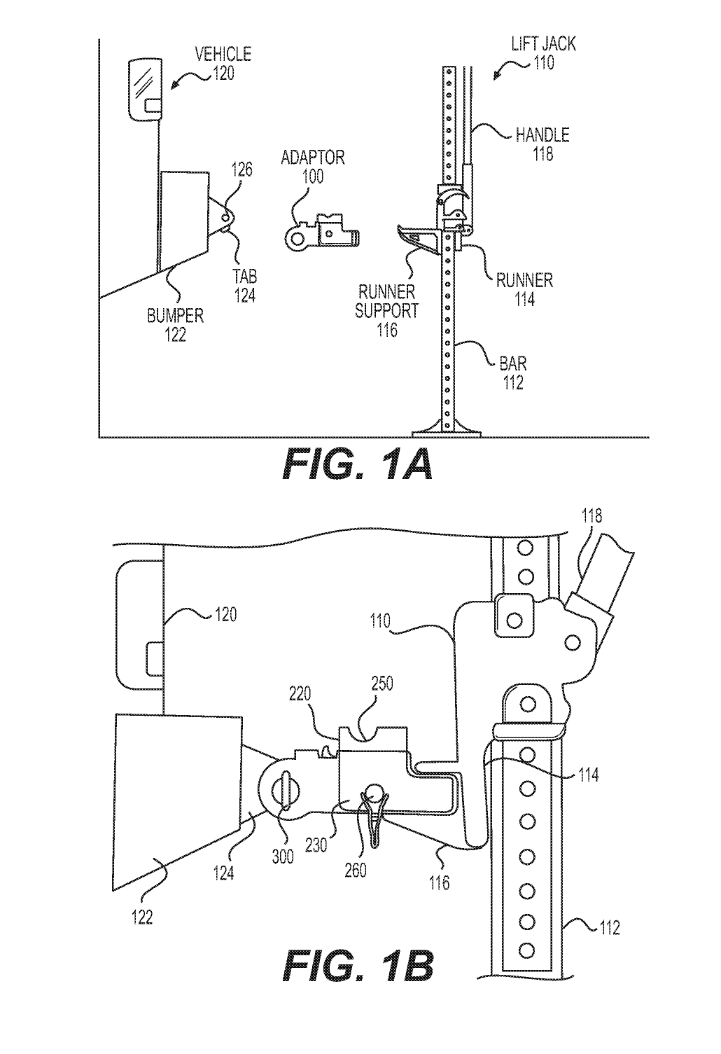

With reference first to FIGS. 1A and 1 B, there are shown simplified side views of an adaptor 100, a lift jack 110, and a rear portion of a vehicle 120, according to an example. It should be understood that the elements depicted in FIGS. 1A and 1B may include additional components and that elements may not be drawn to scale and thus, the elements may have different sizes and/or configurations other than as shown therein.

As shown in FIG. 1A, the lift jack 110 may include a bar 112, a runner 114 having a runner support 116, and a handle 118. In addition, the vehicle 120 may include a bumper 122 and a tab 124, which is connected to the bumper 122. The tab 124 may be rigidly connected to the bumper 122 and the bumper 122 may be attached to a frame or a frame-mounted tubular or flat skid rail (not shown) of the vehicle 120. Particularly, the tab 124 includes an opening 126 through which a “D”-ring or an “O”-ring may be inserted. Additionally, the tab 124 may have sufficient strength and may be connected to the bumper 122 with a sufficiently strong connection to enable, for instance, at least a portion of the weight of the vehicle 120 to be supported by the tab 124 without the tab 124 breaking or detaching from the bumper 122. Likewise, the bumper 122 may be formed of a material having sufficient strength and may be attached to the vehicle 120 frame with a sufficiently strong attachment to enable, for instance, at least a portion of the weight of the vehicle 120 to be supported by the bumper 122 without the bumper 122 breaking or detaching from the vehicle 120 frame. Particularly, for instance, the bumper 122 and the tab 124 may be of sufficient strength to enable a portion of the vehicle 120 to be lifted a sufficient distance from the ground to enable a tire of the vehicle 120 to be removed.

The lift jack 110 may be suited for lifting vehicles that have relatively large ground clearances, such as all-terrain vehicles, four-wheel drive vehicles, Jeep™ vehicles, etc. In other words, the bar 112 may be relatively tall to accommodate the large ground clearances. In a normal operation, the lift jack 110 may be employed by placing the runner support 116 underneath a frame or a frame-mounted tubular or flat skid rail of a vehicle 120 and manipulating the handle 118 to cause the runner 114 to be jacked up the bar 112 and thus lift the vehicle 120.

According to an example, and as shown in FIG. 1B, the adaptor 100 is to receive the tab 124 through a first end of the adaptor 100 and to receive the runner support 116 through a second end of the adaptor 100. In this regard, the adaptor 100 may enable at least a portion of the vehicle 120 to be lifted by lifting of the tab 124 using the lift jack 110. Lifting of the vehicle 120 in this manner may be relatively simpler and safer than lifting of the vehicle 120 following positioning of the runner support 116 underneath a portion of the vehicle 120 frame or a frame-mounted tubular or flat-skid rail. For instance, placement of the runner support 116 underneath a portion of the vehicle 120 frame or frame-mounted skid rail typically requires that a user find an appropriate location on the frame or frame-mounted skid rail for the runner support 116 as well as to correctly place the runner support 116 underneath the frame or a frame-mounted tubular or flat skid rail, which may be difficult and/or time consuming.

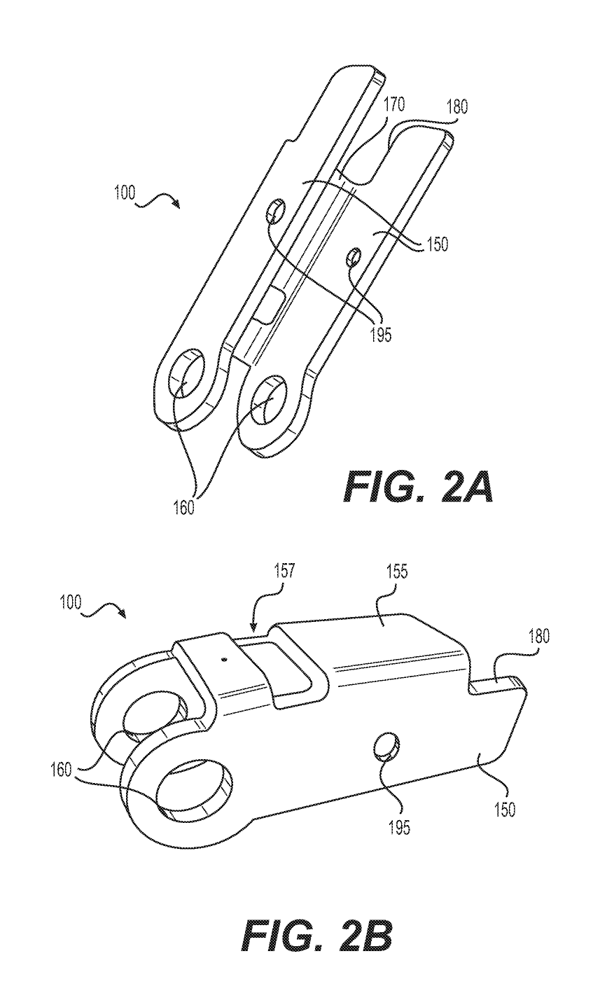

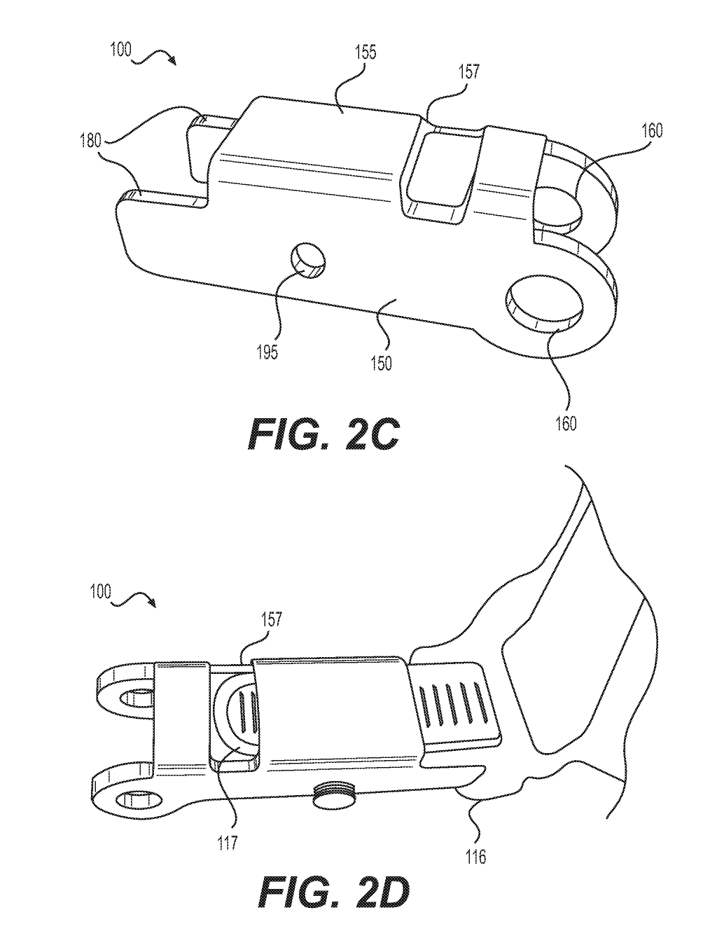

Turning now to FIG. 2A, there is shown a side perspective view, of the adaptor 100, according to an example. It should be understood that the adaptor 100 depicted in FIG. 2 may include additional elements and that some of the elements depicted therein may be removed and/or modified without departing from a scope of the adaptor 100.

The adaptor 100 is depicted as a structure that has a generally rectangular shape and includes a pair of coextensive segments 150. The coextensive segments 150 are also depicted as including a pair of openings 160 located near first ends of the coextensive segments 150. The pair of openings 160 may be of any suitable shape and/or size to enable a coupling pin 300 (shown in FIG. 1B) to be received therethrough. The coupling pin 300 may be inserted through the pair of openings 160 in the coextensive segments 150 and the opening 126 in a tab 124 of a vehicle 120 to secure the adaptor 100 to the vehicle 120.

The pair of coextensive segments 150 of the adaptor 100 define a space 170 to receive the runner support 116 of a lift jack 110 through a second end of the adaptor 100. The space 170 may also be maintained by a support rod (not shown) that may extend from one coextensive segment 150 to the other. The support rod, if included, generally provides strength and support to the pair of coextensive segments 150.

As also shown in FIG. 2A, the second end of the pair of coextensive segments 150 may each include a notch 180, in which the notches 180 are to receive a portion of the runner support 116 of a lift jack 110. Particularly, the notches 180 may be provided on each coextensive segment 150 to accommodate features of the runner support 116. In this regard, the coextensive segments 150 may be formed to include any number of variously configured elements to accommodate features of various types of runner supports 116. In one regard, the notches 180 enable a secure fit between the runner support 116 and the adaptor 110.

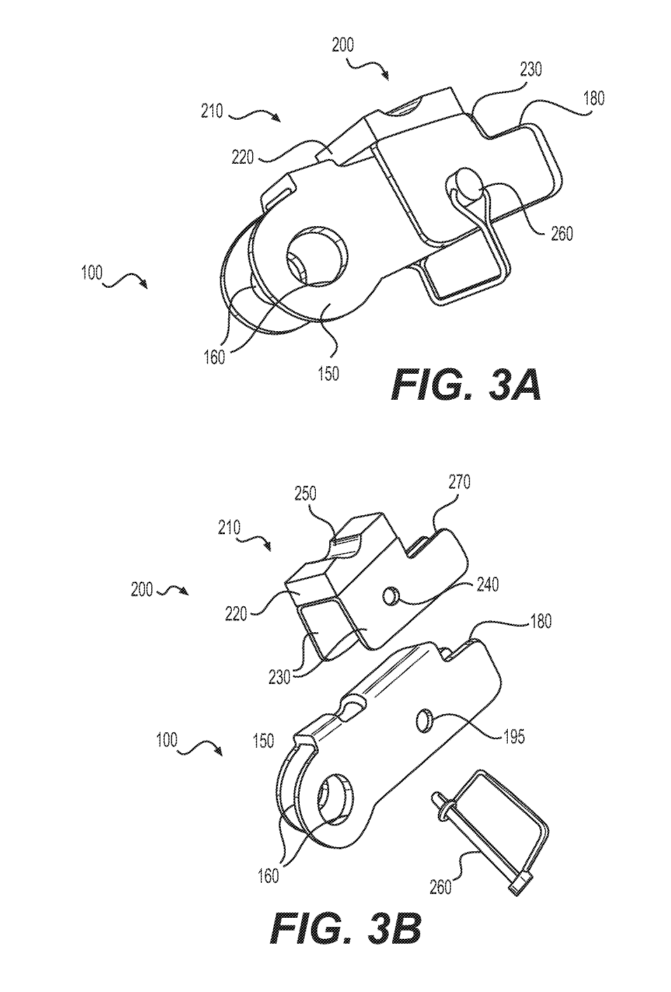

The pair of coextensive segments 150 may further include a first pair of holes 195. The first pair of holes 195 may be of any suitable size and/or shape to receive a locking pin 260 (shown in FIGS. 3A and 3B).

According to an example, the adaptor 100 may be formed of a single sheet of material such as metal, metal alloy, plastic, composite materials, or the like. For instance, the adaptor 100 may be formed by stamping or bending a sheet of metal to have a particular configuration and the stamped or bent sheet of material may be further bent into the shape of the adaptor shown in FIG. 2A. As another example, the adaptor 100 may be formed through a molding process.

Turning now to FIGS. 2B and 2C, there are respectively shown top perspective views of the adaptor 100. As shown in FIGS. 2B and 2C, the coextensive segments 150 are connected each other via a top segment 155. Particularly, the coextensive segments 150 are depicted as extending at approximately 90 degree angles from the top segment 155. Additionally, the top segment 155 is depicted as including an aperture 157 located near a first end of the adaptor 100, i.e., on a side of the adaptor 100 that is nearer the pair of openings 160. In one regard, and as shown in FIG. 2D, the aperture 157 may enable a tip 117 of the runner support 116 to extend therethrough.

The adaptor 100 may be part of an adaptor system 200, as shown in FIGS. 3A-B, which respectively show a perspective view and an exploded view of the adaptor system 200, according to an example. It should be understood that the adaptor system 200 depicted in FIGS. 3A-B may include additional elements and that some of the elements depicted therein may be removed and/or modified without departing from a scope of the adaptor system 200.

The adaptor system 200 may include the adaptor 100 depicted in FIGS. 1A, 1B, and 2A-2D, a saddle 210, and a locking pin 260. The adaptor 100 for use in the adaptor system 200 has been described above.

The saddle 210 includes a top section 220 that extends into parallel segments 230. The top section 220 may be formed of a material that is the same as or different from the parallel segments 230. In an embodiment, the top section 220 is formed of a different material from the parallel segments 230. In this embodiment, the top section 220 may be attached to a section that connects the parallel segments 230. Additionally, the top section 220 may be formed of a plastic material, a composite material, a polymer material, etc. According to an example, the top section 220 is formed of a block of material that is not to damage a frame or a frame-mounted rail of the vehicle 120.

The top section 220 is also depicted as including a groove 250 formed on the surface of the top section 220. According to an example, the top section 220 may provide a contact surface in instances in which the adaptor system 200 is used in a manner different than the implementation depicted in FIGS. 1A and 1B. In this example, the adaptor system 200 may be positioned underneath the vehicle 120, for instance, under a frame or a frame-mounted rail of the vehicle 120. In addition, the frame or the frame-mounted rail of the vehicle 120 may be positioned in the groove 250 to provide a more stable contact between the adaptor 100 and the vehicle 120. The groove 250 may have a depth sufficient to contact and optionally retain a frame or a frame-mounted rail of the vehicle 120.

The parallel segments 230 of the saddle 210 may include a second pair of holes 240. The second pair of holes may be of any suitable size and/or to receive a locking pin 260. As shown in FIG. 3A, the saddle 210 may be positioned over the adaptor 100 so that the parallel segments 230 of the saddle 210 extend over the coextensive segments 150 of the adaptor 100. In this manner, the first pair of holes 195 of the coextensive segment 150 of the adaptor 100 may be aligned with the second pair of holes 240 of the parallel segments 230 of the saddle 210. A locking pin 260 may be inserted into the first and second pair of holes 195, 240 and may secure the saddle 210 to the adaptor 100. The parallel segments 230 may also each include a cutout 270, in which the cutouts 270 are to receive a portion of the runner support 116 of a lift jack 110. Particularly, the cutouts 270 may be provided on each parallel segment 230 to accommodate features of the runner support 116. In this regard, the parallel segments 230 may be formed to include any number of variously configured elements to accommodate features of various types of runner supports 116. In one regard, the cutouts 270 enable a secure fit between the runner support 116 and the adaptor 110.

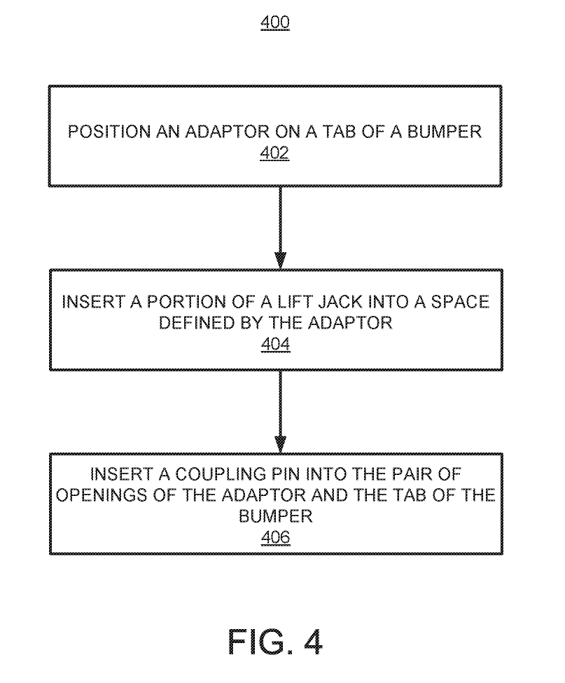

Turning now to FIG. 4, there is shown a flow diagram of a method 400 for implementing an adaptor to lift a vehicle, according to an example. It should be apparent to those of ordinary skill in the art that the method 400 may represent generalized illustrations and that other operations may be added or existing operations may be removed, modified, or rearranged without departing from the scope of the method 400.

The description of the method 400 is made with reference to the adaptor 100 illustrated in FIGS. 1A-3B for purposes of illustration. It should, however, be clearly understood that apparatuses having other configurations may be implemented to perform the method 400 without departing from the scope of the method 400.

At block 402, an adaptor 100 may be positioned on a tab 124 of a vehicle 120 to cause the tab 124 to be positioned between the pair of openings 160 of the coextensive segments 150 of the adaptor 100 so that an opening 126 of the tab 124 is aligned with the pair of openings 160.

At block 404, a portion of a lift jack 110 may be inserted into a space 170 defined by the pair of coextensive segments 150 of the adaptor 100. The coextensive segments 150 are spaced apart from each other and include features, e.g., notches 180, to securely contact the runner support 116 of the lift jack 110.

At block 406, a coupling pin 300 may be inserted through the pair of openings 160 of the adaptor 100 and through the opening 126 in the tab 124 of the bumper 122.

The handle 118 of the lift jack 110 may be manipulated to jack up the runner 114 and thus the vehicle 120 via the tab 124.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein are examples of the disclosure along with some variations. The terms, descriptions and figures used herein are set forth by way of illustration only and are not meant as limitations. Many variations are possible within the scope of the disclosure, which is intended to be defined by the following claims—and their equivalents—in which all terms are meant in their broadest reasonable sense unless otherwise indicated.

What is claimed is:

1. An adaptor for a lift jack, said adaptor comprising:
a pair of coextensive segments having a pair of openings at a first end, and defining a space to receive a portion of a lift jack at a second end;
a coupling pin to be inserted through the pair of openings to secure the adaptor to a vehicle, and
wherein the second end of the coextensive segments has a notch on each segment of the pair of coextensive segments to receive the portion of the lift jack.

2. The adaptor of claim 1, further comprising a top segment interconnecting the pair of coextensive element and maintaining the pair of coextensive elements in spaced relationship with respect to each other.

3. The adaptor of claim 2, wherein the top segment includes an aperture through which a portion of the lift jack is to be inserted.

4. The adaptor of claim 1, wherein the pair of coextensive segments further comprises a first pair of holes to receive a locking pin.

5. An adaptor system for use with a lift jack, the system comprising:
an adaptor having a pair of coextensive segments including a pair of openings at a first end, and defining a space to receive a portion of a lift jack at a second end, wherein the pair of openings are to receive a coupling pin to secure the adaptor to a vehicle;
a saddle having a top section and parallel segments, wherein the parallel segments include a second pair of holes to receive a locking pin; and
a locking pin for connecting the adaptor and the saddle.

6. The system of claim 5, wherein the second end of the coextensive segments of the adaptor has a notch on each segment of the pair of coextensive segments to receive the portion of the lift jack.

7. The system of claim 6, wherein the saddle includes cutouts on the parallel segments, wherein the cutouts are aligned with the notches on the coextensive segments when the saddle is aligned with the adaptor.

8. The system of claim 5, wherein the pair of coextensive segments of the adaptor further comprises a first pair of holes to receive the locking pin.

9. The system of claim 8, wherein the saddle is positioned over the adaptor so that the first pair of holes is aligned with the second pair of holes to allow insertion of the locking pin into the first and second pairs of holes.

10. The system of claim 5, wherein the top section of the saddle further comprises a relatively flat surface with a groove.

11. The system of claim 10, wherein the groove has a depth sufficient to contact and optionally retain a frame or a frame-mounted rail of the vehicle.

12. The system of claim 5, wherein the top section of the saddle comprises a material that differs from the parallel segments.

13. The system of claim 5, wherein the coextensive segments of the adaptor are spaced a sufficient distance apart from each other to enable a runner support of the lift jack to be positioned between the coextensive segments and within the space.

14. A method of implementing a lift jack adaptor, said method comprising:
positioning the adaptor on a tab of a bumper attached to a vehicle to cause the tab to be aligned with a pair of openings on a pair of coextensive segments of the adaptor;
inserting a portion of a lift jack into a space defined by the pair of coextensive segments of the adaptor; and
inserting a coupling pin into the pair of openings of the adaptor and an opening in the tab of the bumper.

15. The method of claim 14, further comprising positioning a saddle over the adaptor, wherein the saddle has a top section that extends into parallel segments, wherein the parallel segments include a second pair of holes to receive a locking pin.

16. The method of claim 14, wherein the pair of coextensive segments of the adaptor further comprises a first pair of holes.

17. The method of claim 16, further comprising aligning the first pair of holes of the adaptor with the second pair of holes of the saddle.

18. The method of claim 17, further comprising inserting a locking pin into the first pair of holes of the adaptor and the second pair of holes of the saddle.
